(19) United States
(12) Patent Application Publication
(10) Pub. No.: US 2014/0297667 A1
(43) Pub. Date: Oct. 2, 2014

(54) METHOD AND SYSTEM OF NON-REDUCTIVE INDEXING OF RAW DIGITAL DATA IN HUGE DATA SEARCH PROBLEM SPACES

(71) Applicant: Ian Lawson, Gloucestershire (GB)

(72) Inventor: Ian Lawson, Gloucestershire (GB)

(73) Assignee: CGI IT UK LIMITED, Reading (GB)

(21) Appl. No.: 14/005,990

(22) PCT Filed: Dec. 7, 2011
(86) PCT No.: PCT/EP2011/072061

§ 371 Date: May 2, 2014

(30) Foreign Application Priority Data
Mar. 18, 2011 (IN) 845/CHE/2011

(51) Int. Cl. G06F 17/30; G06F 17/27

(52) U.S. Cl. CPC G06F 17/30336; G06F 17/2705
USPC 707/755

(57) ABSTRACT

The present invention provides a non-reductive normalisation based data indexing and search system and method. In one embodiment, a computer-implemented method for indexing raw digital data in a searchable format includes translating raw digital data in a first data format to a second data format using a set of extensible parsers, forming non-reductive normalised data entities from the digital data in the second format using a set of extensible entity builders, indexing each of the non-reductive normalised data entities in one or more indexes using a set of extensible indexers, and searching the one or more indexes containing the non-reductive normalised data entities for digital data based on a search query for the digital data.

### RELATED APPLICATION

Benefit is claimed to India Provisional Application No. 845/CHE/2011, titled “Non-Reductive Normalization Based Search System and Method” by LAWSON, Ian, et Al., filed on 18 Mar., 2011, which is herein incorporated in its entirety by reference for all purposes.

### FIELD OF THE INVENTION

The present invention generally relates to the field of data indexing and search system, and more particularly relates to a non-reductive indexing and searching of digital data in huge data search problem spaces.

### BACKGROUND OF THE INVENTION

The amount of information within a person's reach, either stored locally on their computer devices (desktop computer, handheld, mobile phone, etc.) or available to them via networks that their personal hardware is connected to, continues to increase. Locating the right information at the right time continues to be a challenging and frustrating problem for computer users. While the development of search engines has significantly increased the ability of computer users to discover or locate information, existing search algorithms still has various significant limitations, and it is frequently insufficient to help people locate the information they need.

Existing search algorithms index original digital data acquired from a data source using a coarse reductive approach. The coarse reductive search algorithms fail to index entire digital content of the original digital data and may lose some of the digital content during indexing the digital data. Hence, the existing search algorithms are inefficient in searching the indexed digital content based on a search query as a part of the digital content is lost while indexing the original digital data. Further, the existing search algorithms work well in a narrow set of situations, such as when the user is able to provide search terms that precisely match the resources they are attempting to locate.

### SUMMARY OF THE INVENTION

The present invention provides non-reductive normalisation based data indexing and search system and method thereof. In one aspect, a computer-implemented method for indexing raw digital data in a searchable format includes translating raw digital data in a first data format to a second data format using a set of extensible parsers, forming non-reductive normalised data entities from the digital data in the second format using a set of extensible entity builders, indexing each of the non-reductive normalised data entities in one or more indexes using a set of extensible indexers, and searching the one or more indexes containing the non-reductive normalised data entities for digital data based on a search query for the digital data.

In another aspect, a non-transitory computer-readable storage medium having instructions stored therein, that when executed by a computing device, cause the computing device to perform the method described above.

In yet another aspect, an apparatus includes a processor, and memory coupled to the processor. The memory includes a non-reductive normalisation tool having a set of extensible parsers operable for translating raw digital data in a first data format to a second data format, a set of extensible entity builders operable for forming non-reductive normalised data entities from the digital data in the second format, and a set of extensible indexers operable for indexing the non-reductive normalised data entities in one or more indexes.

The non-reductive normalisation tool also includes the non-reductive normalisation tool comprises a search module operable for receiving a query for digital data from a client device, substantially simultaneously determining whether the query for digital data matches with the non-reductive normalised data entities corresponding to the data type in each of the one or more indexes, collating search results associated with the query for digital data, and displaying the collated search results on the client device.

In further another aspect, a system includes at least one application server, at least one indexing database, and a plurality of client devices, where the at least one application server includes the non-reductive normalisation tool. The non-reductive normalisation tool includes a set of extensible parsers operable for translating raw digital data in a first data format to a second data format, a set of extensible entity builders operable for forming non-reductive normalised data entities from the digital data in the second format, and a set of extensible indexers operable for indexing the non-reductive normalised data entities in one or more indexes. The non-reductive normalisation tool also includes the non-reductive normalisation tool includes a search module operable for receiving a query for digital data from one of the client devices, substantially simultaneously determining whether the query for digital data matches with the non-reductive normalised data entities corresponding to the data type in each of the one or more indexes, collating search results associated with the query for digital data, and providing the collated search results to one of the client devices.

Other features of the embodiments will be apparent from the accompanying drawings and from the detailed description that follows.

### BRIEF DESCRIPTION OF THE ACCOMPANYING DRAWINGS

FIG. 1 is a block diagram illustrating a non-reductive normalisation tool capable of non-reductive indexing of raw digital data and searching the indexed digital data, according to one embodiment.

FIG. 2 is a process flowchart illustrating an exemplary method of non-reductive indexing of raw digital data in huge data search problem spaces, according to one embodiment.

FIG. 3 is a process flowchart illustrating an exemplary method of searching the indexed digital data in huge data search problem spaces, according to one embodiment.

FIG. 4 illustrates a block diagram of an exemplary network system for implementing one or more embodiments of the present subject matter.

FIG. 5 illustrates a block diagram of an exemplary computing device for implementing one or more embodiments of the present subject matter.

FIG. 6 is a screenshot view illustrating an exemplary index formed using non-reductive normalised entities, according to one embodiment.

FIG. 7 is a screenshot view illustrating search results obtained from the stored indices based on a query for digital data, according to one embodiment.

The drawings described herein are for illustration purposes only and are not intended to limit the scope of the present disclosure in any way.

### DETAILED DESCRIPTION OF THE INVENTION

The present invention provides non-reductive normalisation based data indexing and search system and method thereof. The following description is merely exemplary in nature and is not intended to limit the present disclosure, applications, or uses. It should be understood that throughout the drawings, corresponding reference numerals indicate like or corresponding parts and features.

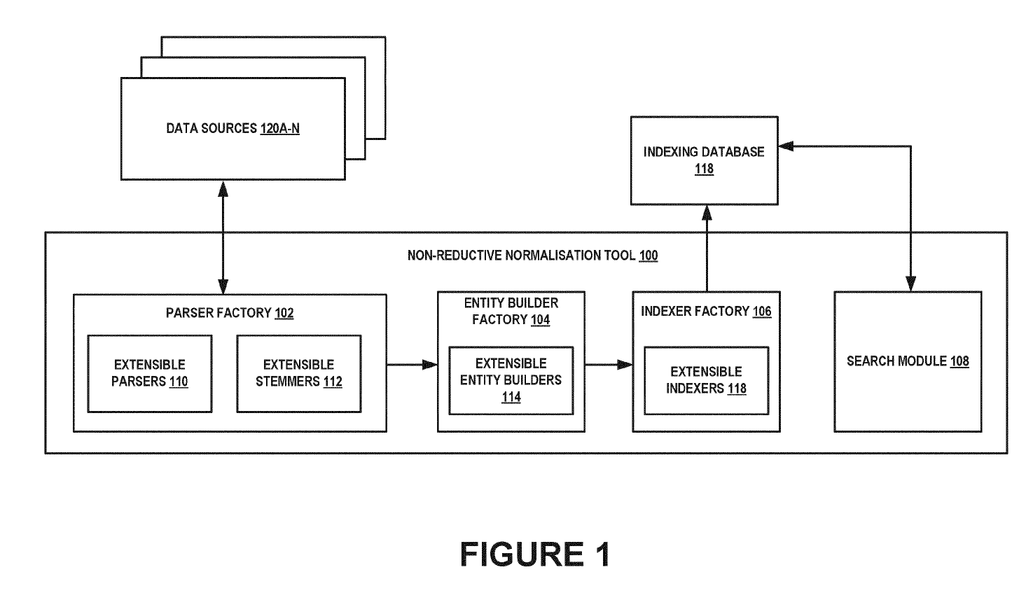

FIG. 1 is a block diagram illustrating a non-reductive normalisation tool 100 capable of non-reductive indexing of raw digital data and searching the indexed digital data, according to one embodiment. In FIG. 1, the non-reductive normalisation tool 100 includes a parser factory 102, an entity builder factory 104 and an indexer factory 106. The non-reductive normalisation tool 100 also includes a search module 108. The parser factory 102 includes a set of extensible parsers 110 and a set of extensible stemmers 112. The entity builder factory 104 includes a set of extensible entity builders 114. The indexer factory 106 includes a set of extensible indexers 116.

In an exemplary operation, the parser factory 102 acquires raw digital data in a specific data format from data sources 120A-N and formats the raw digital data into the uniform data format using the set of extensible parsers 110 (interface class defined in indexing application programming interfaces (APIs)). The parser factory 102 extracts desired digital data from the entire digital data in the uniform data format. Then, the parser factory 102 enriches the extracted digital data depending on context and type associated with the digital data using the set of extensible parsers 110. Additionally, the parser factory 102 stems the enriched digital data using the set of stemmers 112 to obtain lowest linguistic digital data.

The entity builder factory 104 forms non-reductive normalised data entities from the lowest linguistic digital data using the set of entity builders 114 (interface class defined in the indexing application programming interfaces (APIs)). The non-reductive normalised entities refer to entities derived from the lowest linguistic digital data without obscuring or losing content of the lowest linguistic digital data. The entity builder factory 104 forms the non-reductive normalised entities such that the raw digital data does not define limitation of a search. The entity builder factory 104 collates the non-reductive normalised data entities based on the type of the digital data associated with the non-reductive normalised data entities. The indexer factory 106 persists each of the non-reductive normalised data entities associated with digital data using the set of extensible indexers 116 (e.g., indexing API) and stores the persisted non-reductive normalised data entities in one or more indexes. In this manner, the non-reductive normalisation module 100 processes the raw digital data and indexes the processed digital data in a searchable format.

When a user wishes to search for digital data, the user may send a query for digital data. In such case, the search module 108 substantially simultaneously determines whether the queried digital data matches with the normalised data entities corresponding to indexed digital data in each of the indexes using searching API. If the match is found, the search module 108 collates and displays search results for the queried digital data on a display device. If no match is found, the search module 108 displays a notification indicating non-existence of matching digital data on the display device.

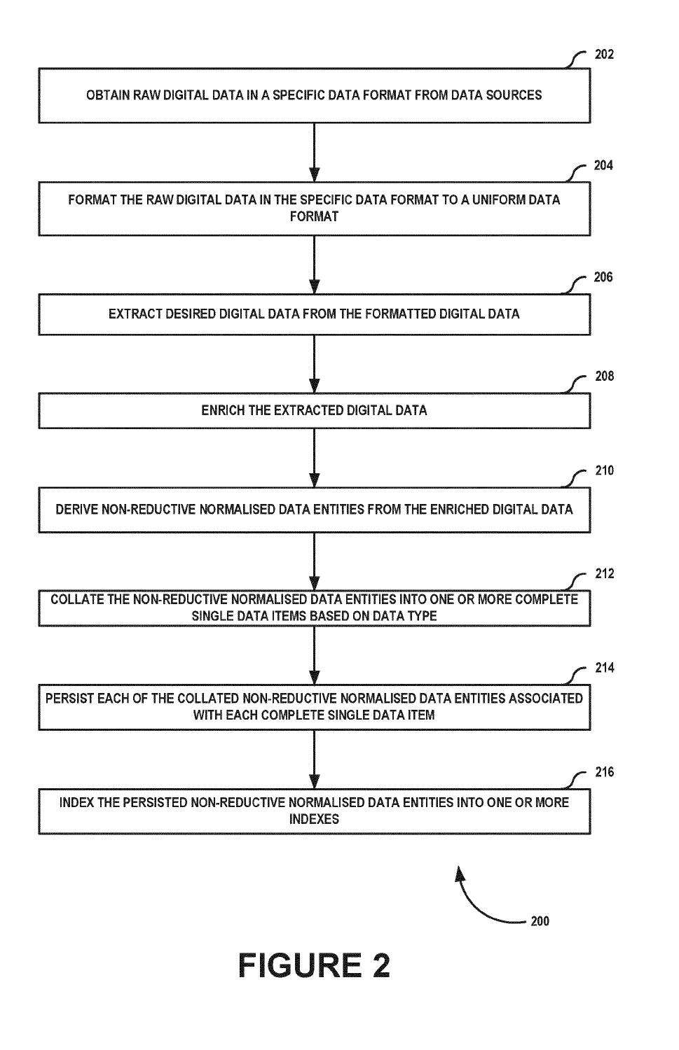

FIG. 2 is a process flowchart 200 illustrating an exemplary method of non-reductive indexing of raw digital data in huge data search problem spaces, according to one embodiment. At step 202, raw digital data in a specific data format is obtained from the data sources 120A-N. At step 204, the raw digital data is formatted into the uniform data format using the set of extensible parsers 110. At step 206, desired digital data is extracted from the entire digital data in the uniform data format using the set of extensible parsers 110.

At step 208, the extracted digital data is enriched depending on context and type associated with the digital data using the set of extensible parsers 110. For example, lowest linguistic digital data is obtained by stemming the extracted digital data using the set of stemmers 112. At step 210, non-reductive normalised data entities are derived from the enriched digital data using the set of entity builders 114.

At step 212, the non-reductive normalised data entities derived from the enriched digital data are collated into one or more complete single data items based on the type of the digital data associated with the non-reductive normalised data entities. At step 214, each of the non-reductive normalised data entities associated with each complete single data item is persisted using the set of extensible indexers 116. At step 216, the persisted non-reductive normalised data entities associated with each complete single data item are indexed in one or more indexes in the indexing database 118.

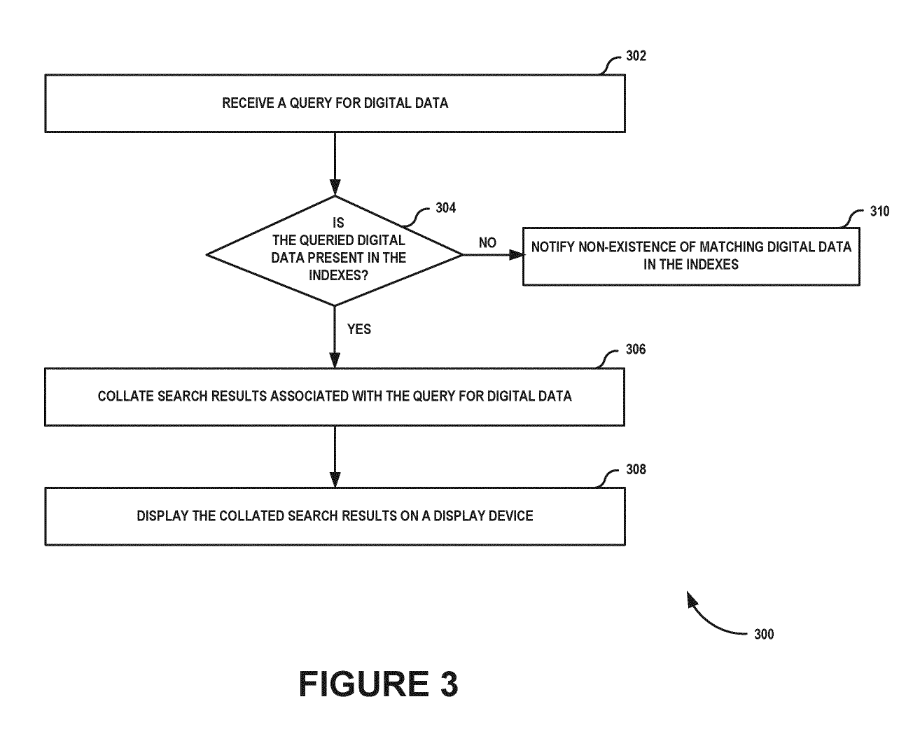

FIG. 3 is a process flowchart 300 illustrating an exemplary method of searching the indexed digital data in huge data search problem spaces, according to one embodiment. At step 302, a query for digital data is received from a client device. At step 304, it is determined whether the queried digital data matches with the non-reductive normalised data entities associated with the digital data in each of the one or more indexes. If the queried digital data is present in the one or more indexes, then at step 306, search results associated with the query for digital data are collated to form final search results for the queries digital data. At step 308, the collated search results for the queried digital data are displayed on a graphical interface of the client device. If the queried digital data does not match, then at step 310, non-existence of matching digital data associated with the query is notified to the user of the client device.

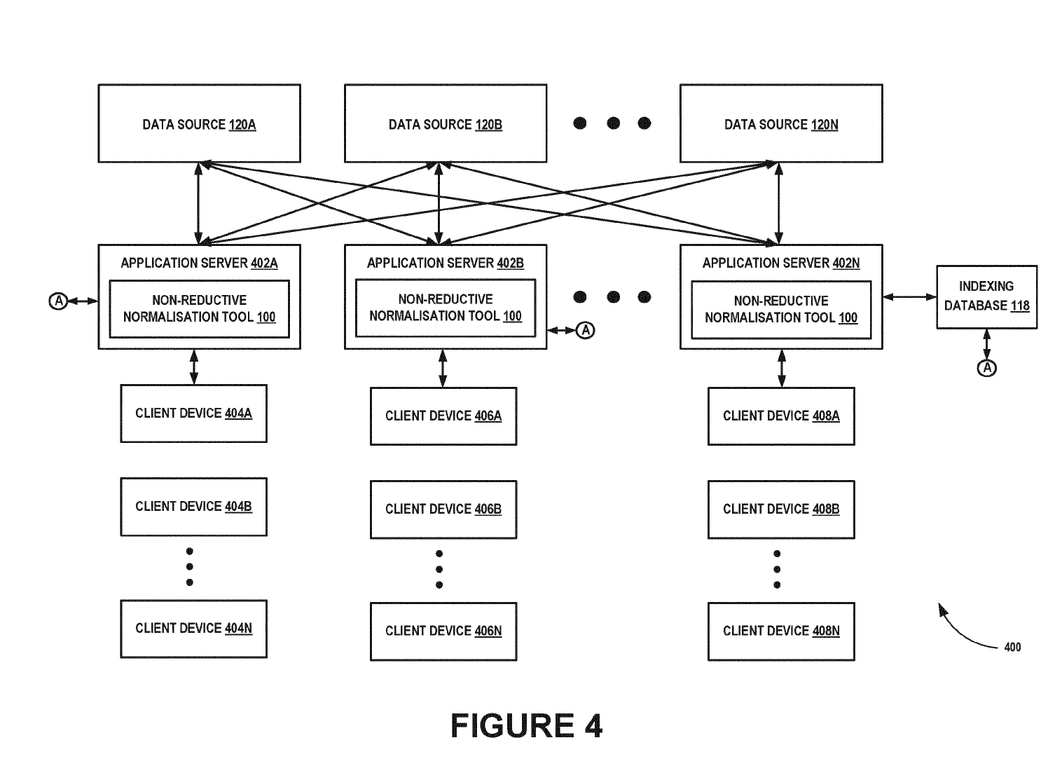

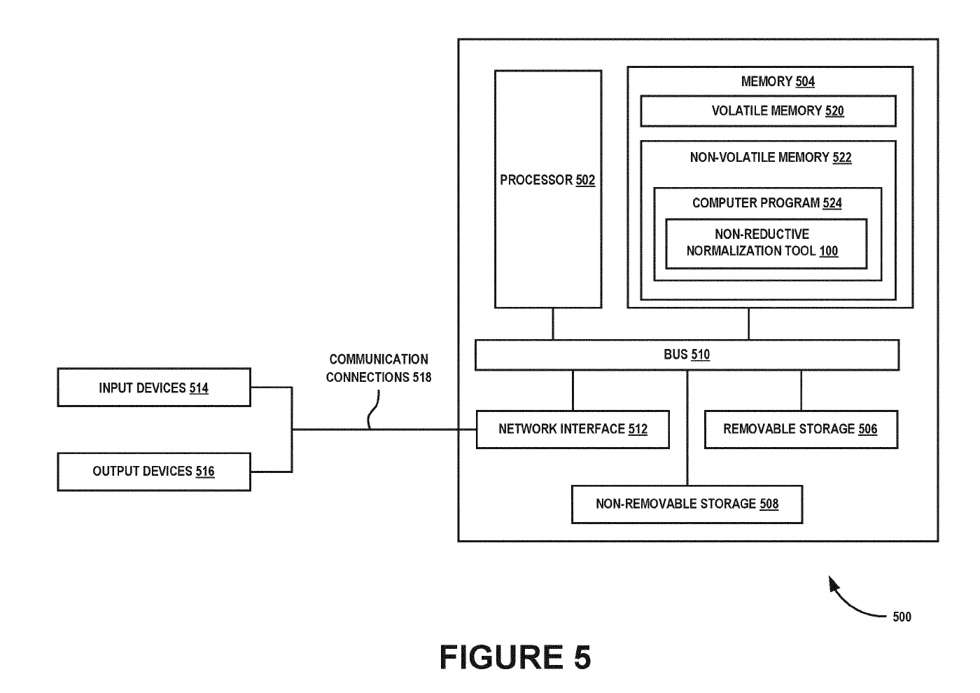

Moreover, in one embodiment, a non-transitory computer-readable storage medium having instructions stored therein, that when executed by a computing device (e.g., application servers 402A-N of FIG. 4 or a computing device 500 of FIG. 5), cause the computing device to perform the method steps illustrated in FIGS. 2 and 3.

FIG. 4 illustrates a block diagram of an exemplary network system 400 for implementing one or more embodiments of the present subject matter. The network system 400 includes data sources 120A-N, application servers 402A-N and the indexing database 118. Each of the application servers 402A-N is connected to the data sources 120A-N. Also, each of the application servers 402A-N is coupled to the indexing database 118.

The network system 400 also includes client devices 404A-N, client devices 406A-N and client devices 408A-N. For example, a client device may be a workstation, a desktop, a laptop, a mobile device and the like. As shown in FIG. 4, the client devices the 404A-N, 406A-N and 408A-N are coupled to the application server 402A, the application server 402B and the application server 402N respectively. Alternatively, the client devices 404A-N, 406A-N and 408A-N can be coupled to a single application server.

The data sources 120A-N include content sources, such as websites, email application, databases, containing raw digital data. The application servers 402A-N include the non-reductive normalisation tool 100 for indexing raw digital data from the data sources 120A-N in a non-reductive manner and providing search results for a search query based on the indexed digital data.

For example, the non-reductive normalisation tool 100 acquires raw digital data in a specific data format from the data sources 120A-N and formats the raw digital data into a uniform data format using the set of extensible parsers 110. The non-reductive normalisation tool 100 extracts desired digital data from the entire digital data in the uniform data format.

The non-reductive normalisation tool 100 forms non-reductive normalised data entities from the extracted digital data using the set of entity builders 114 and collates the non-reductive normalised data entities based on the type of the digital data associated with the non-reductive normalised data entities. The non-reductive normalisation tool 100 persists each of the non-reductive normalised data entities associated with digital data using the set of extensible indexers 116 and stores the persisted non-reductive normalised data entities in one or more indexes in the indexing database 118. In this manner, the non-reductive normalisation tool 100 processes the raw digital data and indexes the processed digital data in a searchable format in the indexing database 118.

When a user wishes to search for digital data, the non-reductive normalisation tool 100 may receive a query for digital data from one or more of the client devices 404A-N, 406A-N, and 408A-N. Accordingly, the non-reductive normalisation tool 100 substantially simultaneously determines whether the queried digital data matches with the normalised data entities corresponding to indexed digital data in each of the indexes. If the match is found, the non-reductive normalisation tool 100 collates and provides search results for the queried digital data to the one or more of the client devices 404A-N, 406A-N and 408A-N. If no match is found, the non-reductive normalisation tool 100 sends a notification indicating non-existence of matching digital data to the one or more of the client devices 404A-N, 406A-N and 408A-N.

FIG. 5 illustrates a block diagram of an exemplary computing device 500 for implementing one or more embodiments of the present subject matter. FIG. 5 and the following discussion are intended to provide a brief, general description of the suitable computing environment in which certain embodiments of the inventive concepts contained herein may be implemented.

The computing device 500 may include a processor 502, memory 504, a removable storage 506, and a non-removable storage 508. The computing device 500 additionally includes a bus 510 and a network interface 512. The computing device 500 may include or have access to one or more user input devices 514, one or more output devices 516, and one or more communication connections 518 such as a network interface card or a universal serial bus connection. The one or more user input devices 514 may be keyboard, mouse, and the like. The one or more output devices 516 may be a display of the computing device 500. The communication connections 518 may include a wireless communication network such as wireless local area network, local area network and the like.

The memory 504 may include volatile memory 520 and non-volatile memory 522. A variety of computer-readable storage media may be stored in and accessed from the memory elements of the computing device 500, such as the volatile memory 520 and the non-volatile memory 522, the removable storage 506 and the non-removable storage 508. Computer memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 502, as used herein, means any type of computational circuit, such as, but not limited to, a microprocessor, a microcontroller, a complex instruction set computing micro-processor, a reduced instruction set computing microprocessor, a very long instruction word microprocessor, an explicitly parallel instruction computing microprocessor, a graphics processor, a digital signal processor, or any other type of processing circuit. The processor 502 may also include embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 502 of the computing device 500.

For example, a computer program 524 may include machine-readable instructions capable of indexing raw digital data in a non-reductive normalised manner and searching the indexed digital data based on a search query, according to the teachings and herein described embodiments of the present subject matter. In one embodiment, the computer program 524 may include the non-reductive normalisation tool 100 for indexing raw digital data in a non-reductive normalised manner and searching the indexed digital data based on a search query. The computer program 524 may be included on a compact disk-read only memory (CD-ROM) and loaded from the CD-ROM to a hard drive in the non-volatile memory 522. The machine-readable instructions may cause the computing device 500 to encode according to the various embodiments of the present subject matter.

According to the foregoing description, consider that the raw digital data consist of information in the following table 1:

TABLE 1

| FIELD NAME | FIELD VALUE |
|---|---|
| Forename | John |
| Surname | Doe |
| Age | 42 |
| Birth Place | Southmead |
| Discussion Text | It is very nice to be able to discuss search |
| | engines in detail with people who appreciate |
| | and understand the complexities |

The non-reductive normalised tool 100 converts the raw digital data in table 1 to a non-reductive normalised entity in table 2 below:

TABLE 2

| ENTITY FIELD NAME | ENTITY FIELD CONTENT |
|---|---|
| system.id | Unique ID |
| system.indexedDate | Date added to index |
| system.entityBuilder | Class used to generate |
| | the entity |
| type.sourceDatabase | Database source |
| | information |
| type.sourceQuery | Exact query used to |
| | attain the data |
| content.forename | John |
| content.surname | Doe |
| content.fullName | John Doe |
| content.age | 42 |
| content.birthPlace | Southmead |
| content.yearOfBirth | 1969 |
| content.discussionText | very nice to be able discuss |
| | search engines in detail |
| | people appreciate understand |
| | complexities |
| content.discussionTextStemmed | very nice be able discuss |
| | search engine in detail |
| | people appreciate understand |
| | complexity |
| content.discussionTextWithStopWords | It is very nice to be able |
| | to discuss search engines in |
| | detail with people who |
| | appreciate and understand |
| | the complexities |
| content.main | John Doe 42 southmead it is |
| | very nice to be able to discuss |
| | search engines in detail with |
| | people who appreciate and |
| | understand the complexities |
| content.mainStemmed | John Doe 42 southmead it is |
| | very nice to be able to discuss |
| | search engine in detail with |
| | people who appreciate and |
| | understand the complexitity |

It can be noted that the digital data that is searchable (any field) contains all the content in the original raw digital data plus enriched digital data (e.g., the year of birth is calculated using the information provided) and additional versions aimed to assist in searching (e.g., by producing stemmed and non-stemmed versions to minimize possibility of missing data when people search for non-stemmed words). It can be noted that, the stemmed/non-stemmed and enrichment behaviour is fully configurable in the non-reductive normalisation tool 100. Thus, the entire searchable content of the raw digital data is available through a single field—content.main. All non-reductive normalised entities regardless of which parsers/entity-builders were sourced from contain the content.main field, thereby allowing all of them to be searched in parallel.

From the above example it can be inferred that, the non-reductive normalisation tool 100 indexes raw digital data as non-reductive normalised entities in such a way that the whole of the raw digital data can be quickly and efficiently searched. That is, the non-reductive normalisation tool 100 is capable of searching for ‘anyone called Ian born in 1969’.

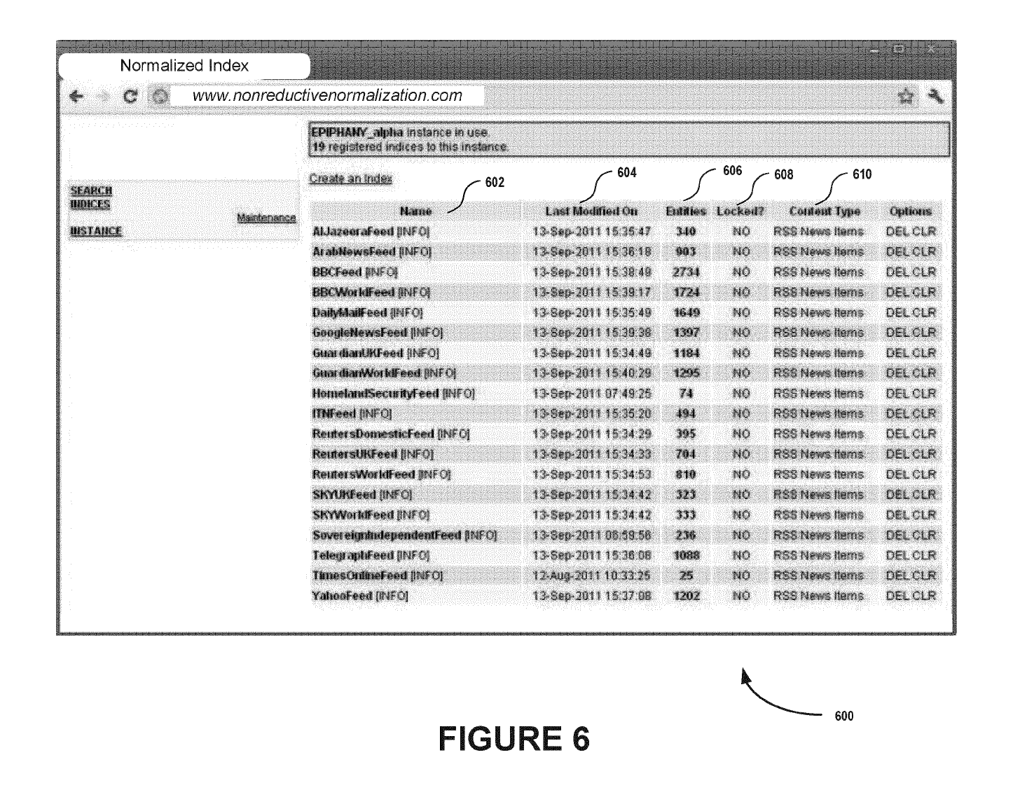

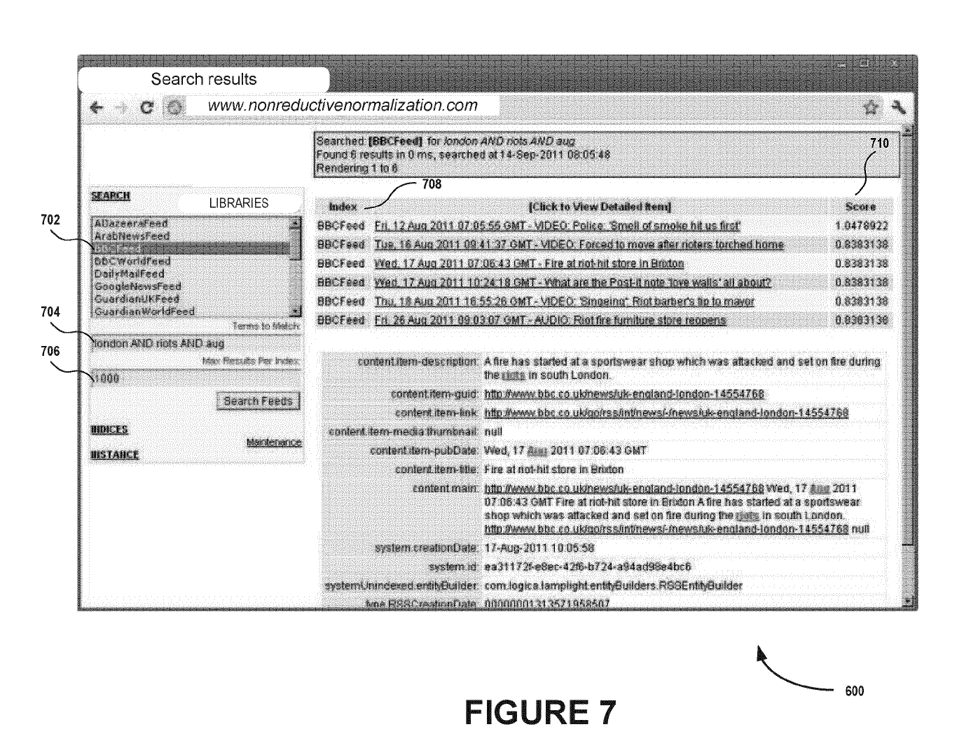

FIG. 6 is a screenshot view illustrating an exemplary index 600 formed using non-reductive normalised entities, according to one embodiment. The index 600 includes a name field 602, a last modified field 604, entities field 606, a locked status field 608, and a content type field 610. As described above, the non-reductive normalised entities associated with the digital data are indexed in the index 600. For example, the index 600 displays nineteen registered indices for ‘Epiphany alpha’ instance. The name field 602 displays names of the registered indices. The last modified field 604 indicates date and time on which the indices or indexed non-reductive normalised entities were recently modified. The entities field 606 indicates number of entities stored in each of the indices. For example, the index ‘AlJazeerafeed’ has 340 entities while the index ‘BBCfeed’ has 2374 entities. The locked status field 608 indicates whether respective indices are locked for modification or not. The content type field 610 indicates a content type associated with each of the indices. The non-reductive normalisation tool 100 enables a user to search digital data stored in the indices with greater flexibility and efficiency as described in FIG. 7.

FIG. 7 is a screenshot view illustrating search results 700 obtained from index 600 based on a query for digital data, according to one embodiment. The libraries field 702 enables the user to select one or more indexes for searching digital data. The query field 704 enables the user to input digital data to be searched for in the selected index(es). The results per index field 706 facilitates the user to restrict the search results for the queried digital data in the selected indexes to a fixed number (e.g., 1000). The index field 708 displays name of the index in which digital data matching the queried digital data is found and a short description of the item. The score field 710 displays a score associated with each search result based on the relevancy of the results to the search query. When the search results are displayed, the user can select the displayed search result for fetching additional description associated with the search result. The additional description may include content item description, content item link, content item title, content item publication date, etc. For example, when the user queries for “London”, “riots” and “aug” in the BBC feed and selects the results “fire at riot-hit store in Brixton”, the content item description includes “A fire has started at a sportswear which was attacked and set on fire during riots in south London” with other associated information such as link to the search result on the web and title of the search result.

It will be recognized that the above described invention may be embodied in other specific forms without departing from the spirit or essential characteristics of the disclosure. Thus, it is understood that, the invention is not to be limited by the foregoing illustrative details, but it is rather to be defined by the appended claims.

We claim:

1. A computer-implemented method for indexing raw digital data in a searchable format comprising:
translating raw digital data in a first data format to a second data format using a set of extensible parsers;
forming non-reductive normalised data entities from the digital data in the second format using a set of extensible entity builders; and
indexing the non-reductive normalised data entities in one or more indexes using a set of extensible indexers.

2. The method of claim 1, wherein translating the raw digital data in the first data format to the second data format using the set of extensible parsers comprises:
obtaining raw digital data in a first data format from at least one data source; and
formatting the raw digital data in the first data format to a second data format using a set of extensible parsers.

3. The method of claim 1, wherein formatting the raw digital data in the first data format to the second data format using the set of extensible parsers comprises:
stemming the formatted digital data to lowest linguistic digital data using a set of extensible stemmers.

4. The method of claim 1, wherein forming the non-reductive normalised data entities from the digital data in the second format using the set of extensible entity builders comprises:
forming the non-reductive normalised data entities from the digital data in the second format; and
collating the non-reductive normalised entities based on data type associated with the digital data.

5. The method of claim 4, wherein indexing said the non-reductive normalised data entities in the one or more indexes using the set of extensible indexers comprises:
persisting the non-reductive normalised data entities corresponding to the data type associated with the digital data using the set of extensible indexers; and
storing the persisted non-reductive normalised data entities in one or more indexes.

6. The method of claim 1, further comprising:
receiving a query for digital data from a client device;
substantially simultaneously determining whether the query corresponding to the digital data matches with the non-reductive normalised data entities in each of the one or more indexes;
if so, collating search results associated with the query for digital data and providing the collated search results to the client device; and
if not, notifying non-existence of matching digital data associated with the query for digital data to the client device.

7. An apparatus comprising:
a processor; and
memory coupled to the processor, wherein the memory comprises a non-reductive normalisation tool, and wherein the non-reductive normalisation tool comprises:
a set of extensible parsers operable for translating raw digital data in a first data format to a second data format;
a set of extensible entity builders operable for forming non-reductive normalised data entities from the digital data in the second format; and
a set of extensible indexers operable for indexing the non-reductive normalised data entities in one or more indexes.

8. The apparatus of claim 7, wherein in translating the raw digital data in the first data format to the second data format, the set of extensible parsers are operable for:
obtaining raw digital data in a first data format from at least one data source; and
formatting the raw digital data in the first data format to a second data format.

9. The apparatus of claim 8, wherein the non-reductive normalisation tool further comprises a set of extensible stemmers operable for stemming the formatted digital data to lowest linguistic digital data.

10. The apparatus of claim 9, wherein in forming the non-reductive normalised data entities from the digital data in the second format, the set of extensible entity builders are operable for:
forming non-reductive normalised data entities from the digital data in the second format; and
collating the non-reductive normalised entities based on data type associated with the digital data.

11. The apparatus of claim 10, wherein in indexing said the non-reductive normalised data entities in the one or more indexes, the set of extensible indexers are operable for:
persisting the non-reductive normalised data entities corresponding to the data type associated with the digital data; and
storing the persisted non-reductive normalised data entities in one or more indexes.

12. The apparatus of claim 7, wherein the non-reductive normalisation tool comprises a search module operable for:
receiving a query for digital data from a client device;
substantially simultaneously determining whether the query for digital data matches with the non-reductive normalised data entities corresponding to the data type in each of the one or more indexes;
if so, collating search results associated with the query for digital data and providing the collated search results to the client device; and
if not, notifying non-existence of matching digital data associated with the query for digital data to the client device.

13. A system comprising:
at least one application server;
at least one indexing database; and
a plurality of client devices; wherein the at least one application server comprises the non-reductive normalisation tool, and wherein the at least one non-reductive normalisation tool comprises:
a set of extensible parsers operable for translating raw digital data in a first data format to a second data format;
a set of extensible entity builders operable for forming non-reductive normalised data entities from the digital data in the second format; and
a set of extensible indexers operable for indexing the non-reductive normalised data entities in one or more indexes in the at least one indexing database.

14. The system of claim 13, wherein in translating the raw digital data in the first data format to the second data format, the set of extensible parsers are operable for:
obtaining raw digital data in a first data format from at least one data source; and
formatting the raw digital data in the first data format to a second data format.

15. The system of claim 14, wherein the non-reductive normalisation tool further comprises a set of extensible stemmers operable for stemming the formatted digital data into lowest linguistic digital data.

16. The system of claim 15, wherein in forming the non-reductive normalised data entities from the digital data in the second format, the set of extensible entity builders are operable for:
forming non-reductive normalised data entities from the digital data in the second format; and
collating the non-reductive normalised entities based on data type associated with the digital data.

17. The system of claim 16, wherein in indexing said the non-reductive normalised data entities in the one or more indexes, the set of extensible indexers are operable for:
persisting the non-reductive normalised data entities corresponding to the data type associated with the digital data; and
storing the persisted non-reductive normalised data entities in one or more indexes in the at least one indexing database.

18. The system of claim 13, wherein the non-reductive normalisation tool comprises a search module operable for:
receiving a query for digital data from at least one of the plurality of client devices;
substantially simultaneously determining whether the query for digital data matches with the non-reductive normalised data entities corresponding to the data type in each of the one or more indexes;
if so, collating search results associated with the query for digital data and providing the collated search results to the at least one of the plurality of client devices; and
if not, notifying non-existence of matching digital data associated with the query for digital data to the at least one of the plurality of client devices.

19. A non-transitory computer-readable storage medium having instructions stored therein, that when executed by a computing device, cause the computing device to perform a method comprising:
translating raw digital data in a first data format to a second data format;
forming non-reductive normalised data entities from the digital data in the second format using a set of extensible entity builders; and
indexing the non-reductive normalised data entities in one or more indexes.

20. The storage medium of claim 19, wherein the method further comprises:
receiving a query for digital data from a client device;
substantially simultaneously determining whether the query for digital data matches with the non-reductive normalised data entities corresponding to the data type in each of the one or more indexes;
if so, collating search results associated with the query for digital data and providing the collated search results to the client device; and
if not, notifying non-existence of matching digital data associated with the query for digital data to the client device.
